(19) United States
(12) Patent Application Publication
(10) Pub. No.: US 2014/0213697 A1
(43) Pub. Date: Jul. 31, 2014

(54) 2,2',6,6'-TETRAMETHYL-4,4'-METHYLENEBIS(CYCLOHEXYLAMINE) AS HARDENER FOR EPOXY RESINS

(71) Applicant: BASF SE, Ludwigshafen (DE)

(72) Inventors: Achim KAFFEE, Osnabrueck Luestringen (DE); Miran YU, Ludwigshafen (DE); Monika CHARRAK, Ludwigshafen (DE); Kirsten DAHMEN, Bad Duerkheim (DE); Veit STEGMANN, Mannheim (DE); Gerd HADERLEIN, Gruenstadt (DE); Alexander PANCHENKO, Ludwigshafen (DE)

(73) Assignee: BASF SE, Ludwigshafen (DE)

(21) Appl. No.: 14/164,378

(22) Filed: Jan. 27, 2014

Related U.S. Application Data
(60) Provisional application No. 61/757,263, filed on Jan. 28, 2013.

(51) Int. Cl. C08G 59/14; C08K 7/06; D06M 15/55; C08K 7/14

(52) U.S. Cl. CPC C08G 59/1438; C08K 7/14; C08K 7/06; D06M 15/55
USPC 523/466; 525/524; 523/468; 523/400

(57) ABSTRACT

The present invention relates to a curable composition which comprises epoxy resin, epoxy-group-bearing reactive diluent and the hardener 2,2′,6,6′-tetramethyl-4,4′-methylenebis(cyclohexylamine), curing thereof, and the cured epoxy resin obtainable therefrom, and the use of 2,2′,6,6′-tetramethyl-4,4′-methylenebis(cyclohexylamine) as a hardener for epoxy resins in curable compositions with epoxy-group-bearing reactive diluent.

The present invention relates to a curable composition which comprises epoxy resin, epoxy-group-bearing reactive diluent and the hardener 2,2′,6,6′-tetramethyl-4,4′-methylenebis(cyclohexylamine) (2,6-TMDC), where said curable composition is in essence free from aromatic diamines. The invention also relates to the use of 2,6-TMDC as a hardener for epoxy resins in curable compositions with epoxy-group-bearing reactive diluent. The invention further relates to the curing of the curable composition, and also to the cured epoxy resin obtained via curing of the curable composition.

Epoxy resins are well known and, because of their toughness, flexibility, adhesion, and chemicals resistance, are used as materials for surface coating, and as adhesives, and for molding and lamination processes. In particular, epoxy resins are used for producing carbon-fiber-reinforced or glass-fiber-reinforced composite materials.

Epoxy materials are polyethers and can by way of example be produced via condensation of epichlorohydrin with a diol, an example being an aromatic diol such as bisphenol A. Said epoxy resins are then cured via reaction with a hardener, typically a polyamine.

By way of example, an amino compound having two amino groups can be used to cure epoxy compounds having at least two epoxy groups via a polyaddition reaction (chain extension). Amino compounds having high reactivity are generally added only briefly before curing is desired. Systems of this type are therefore what are known as two-component (2C) systems.

Aminic hardeners are in principle divided in accordance with their chemical structure into aliphatic, cycloaliphatic, or aromatic types. Another possible classification uses the degree of substitution of the amino group, which can be either primary, secondary, or tertiary. However, a catalytic mechanism of curing for epoxy resins is postulated for the tertiary amines, whereas in the case of the secondary and primary amines stoichiometric curing reactions are thought to be the basis for construction of the polymer network.

It has generally been shown that, within the primary amine hardeners, the highest reactivity in epoxy curing is shown by the aliphatic amines. The cycloaliphatic amines usually react somewhat more slowly, while the aromatic amines (amines in which the amino groups have direct bonding to a C atom of the aromatic ring) exhibit by far the lowest reactivity.

These known reactivity differences are utilized during the hardening of epoxy resins in order to permit adjustment of the time available for processing, and of the mechanical properties of the hardened epoxy resins, in accordance with requirements.

Rapid-hardening systems with curing times of ≦10 min, e.g. adhesives, often use short-chain aliphatic amines, whereas the production of large-surface-area composite materials demands a longer pot life, in order that the mold can be filled uniformly and that adequate impregnation of the reinforcing fibers can be ensured. Amines used here are mainly cycloaliphatic, an example being isophoronediamine (IPDA), 4,4′-diaminodicyclohexylmethane (dicykan), 3,3′-dimethyl-4,4′-diaminodicyclohexylmethane (dimethyldicykan), hydrogenated bisanilin A (2,2-di(4-aminocyclohexyl)propane), hydrogenated toluenediamines (for example 2,4-diamino-1-methylcyclohexane or 2,6-diamino-1-methylcyclohexane), 1,3-bis(aminomethyl)cyclohexane (1,3-BAC). Even longer hardening times could be achieved via the use of aromatic polyamines, such as phenylenediamines (ortho, meta, or para), bisanilin A, toluenediamines (for example 2,4-toluenediamine or 2,6-toluenediamine), diaminodiphenylmethane (DDM), diaminodiphenyl sulfone (DDS), 2,4-diamino-3,5-diethyltoluene, or 2,6-diamino-3,5-diethyltoluene (DETDA 80). The use of mixtures of aromatic diamines with certain cycloaliphatic diamines as hardeners for epoxy resins has also been described (EP 2,426,157 A). However, these aromatic polyamines generally have problematic toxicology.

In very recent times, particular importance has been attached to the use of epoxy resins for producing large-surface-area fiber-reinforced composite materials, for example for rotor blades used in the construction of wind turbines. Problem-free injection has to be ensured, because of the enormous size of the components. The implication of that for the epoxy resin systems is that an adequately long time available for processing, i.e. an adequately long pot life, must be reliably provided, in which the viscosity of the system remains low and no gelling occurs. If the systems are too reactive, it is impossible to achieve complete filling of the large mold. On the other hand, however, the resin/hardener mixture must harden completely within a few hours after the mold-filling operation, even at temperatures<120° C., and must give adequately stable properties of the material, since the blades are subsequently required to withstand enormous loads.

The addition of reactive diluents is frequently required in order to keep the starting viscosity as low as possible, particularly for the manufacturing of large structural components. However, such an addition of reactive diluents usually results in an undesirable and significant decrease of the glass transition temperature (Tg) of the cured material.

Cycloaliphatic polyamines that feature particularly long pot lives, and that therefore feature the possibility of particularly long times available for processing, are in particular dimethyldicykan and 2,2′,5,5′-tetramethyl-4,4′-methylenebis(cyclohexylamine) (2,5-TMDC, also known as 2,2′,5,5′-tetramethylmethylenedicyclohexylamine (TMMDCHA)) (U.S. Pat. No. 4,946,925), the reactivity of these being subject to steric hindrance by virtue of the methyl group in ortho-position with respect to the amino group.

DE 2945614 describes the synthesis of 2,2′,6,6′-tetramethylmethylenedicyclohexylamine (2,6-TMDC) and mentions its use as hardener for epoxy resins without going into details of such a use.

It would be desirable to have a curable composition which comprises epoxy resins, reactive diluents and aminic hardeners with pot lives even longer and therefore times available for processing even longer than those which have dimethyldicykan or 2,5-TMDC as hardener, but where said curable composition comprise no aromatic diamines, and where this is achieved without any sacrifice of structural properties (for example the glass transition temperature) of the cured epoxy resin.

The object underlying the invention can therefore be considered to be the provision of a curable composition which comprises epoxy resin, reactive diluent and nonaromatic, aminic hardener which have particularly long pot lives (or long gel times, or slow isothermal viscosity rises), and which therefore can give particularly long times available for processing at the same time as good structural properties of the cured epoxy resin (for example the glass transition temperature).

Accordingly, the present invention provides a curable composition which comprises one or more epoxy resins, one or more epoxy-group-bearing reactive diluents and 2,2′,6,6′-tetramethyl-4,4′-methylenebis(cyclohexylamine) (2,6-TMDC) as hardener, where said curable composition is in essence free from aromatic diamines, and preferably from aromatic amines.

For the purposes of this invention, the expression “in essence free” means that the proportion, based on the entire curable composition, is ≦5% by weight, preferably ≦1% by weight, particularly preferably ≦0.1% by weight.

One particular embodiment of the invention provides a curable composition which comprises one or more epoxy resins, one or more epoxy-group-bearing reactive diluents and 2,6-TMDC, where said curable composition is free from aromatic diamines, and preferably from aromatic amines.

Reactive diluents are generally compounds which reduce the initial viscosity of the curable composition and during the course of the curing of the curable composition enter into chemical bonding with the network that forms from epoxy resin and hardener, such as e.g. cyclic carbonates or low-molecular-weight aliphatic bisglycidyl compounds. For the purposes of this invention, epoxy-group-bearing reactive diluents are organic, preferably aliphatic and preferably low-molecular-weight (Mw<300 g/mol) compounds having one or more epoxy groups, preferably having several epoxy groups, particular preferably having two epoxy groups.

Epoxy-group-bearing reactive diluents of the invention are preferably those selected from the group consisting of 1,4-butanediol bisglycidyl ether, 1,6-hexanediol bisglycidyl ether (HDDE), glycidyl neodecanoate, glycidyl versatate, 2-ethylhexyl glycidyl ether, neopentyl glycol diglycidyl ether, p-tert-butyl glycidic ether, butyl glycidic ether, C₈-C₁₀-alkyl glycidyl ether, C₁₂-C₁₄-alkyl glycidyl ether, nonylphenyl glycidic ether, p-tert-butylphenyl glycidic ether, phenyl glycidic ether, o-cresyl glycidic ether, polyoxypropylene glycol diglycidic ether, trimethylolpropane triglycidic ether (TMP), glycerol triglycidic ether, triglycidylpara-aminophenol (TGPAP), divinylbenzyl dioxide, and dicyclopentadiene diepoxide. They are particularly preferably those selected from the group consisting of 1,4-butanediol bisglycidyl ether, 1,6-hexanediol bisglycidyl ether (HDDE), 2-ethylhexyl glycidyl ether, C₈-C₁₀-alkyl glycidyl ether, C₁₂-C₁₄-alkyl glycidyl ether, neopentyl glycol diglycidyl ether, p-tert-butyl glycidic ether, butyl glycidic ether, nonylphenyl glycidic ether, p-tert-butylphenyl glycidic ether, phenyl glycidic ether, o-cresyl glycidic ether, trimethylolpropane triglycidic ether (TMP), glycerol triglycidic ether, divinylbenzyl dioxide, and dicyclopentadiene diepoxide. They are in particular those selected from the group consisting of 1,4-butanediol bisglycidyl ether, C₈-C₁₀-alkyl monoglycidyl ether, C₁₂-C₁₄-alkyl monoglycidyl ether, 1,6-hexanediol bisglycidyl ether (HDDE), neopentyl glycol diglycidyl ether, trimethylolpropane triglycidic ether (TMP), glycerol triglycidic ether, and dicyclopentadiene diepoxide. Particular preferred are those selected from the group consisting of 1,4-butanediol bisglycidyl ether, C₈-C₁₀-alkyl monoglycidyl ether, C₁₂-C₁₄-alkyl monoglycidyl ether, and 1,6-hexanediol bisglycidyl ether (HDDE).

The proportion made up by the epoxy-group-bearing reactive diluents of the invention in the curable composition, based on the resin component (epoxy resin and any reactive diluents used) is preferably up to 30% by weight, particularly preferably up to 25% by weight, in particular from 1 to 20% by weight. It is preferable that the proportion made up by the reactive diluents of the invention, based on the entire curable composition, is up to 25% by weight, particularly preferably up to 20% by weight, in particular from 1 to 15% by weight.

The curable composition of the invention can also comprise other aliphatic and cycloaliphatic polyamines alongside 2,6-TMDC. It is preferable that the amount made up by 2,6-TMDC, based on the total amount of the aminic hardeners in the curable composition, is at least 50% by weight, particularly preferably at least 80% by weight, very particularly preferably at least 90% by weight. In one particular embodiment, the curable composition comprises no other 2,2′,6,6′-tetraalkyl-4,4′-methylenebis(cyclohexylamine) compounds alongside 2,6-TMDC. In one preferred embodiment, the curable composition comprises no other aminic hardeners alongside 2,6-TMDC. For the purposes of the present invention, an aminic hardener is an amine with NH functionality≧2 (and accordingly by way of example a primary monoamine has NH functionality 2, a primary diamine has NH functionality 4, and an amine having 3 secondary amino groups has NH functionality 3).

Epoxy resins of this invention have from 2 to 10, preferably from 2 to 6, very particularly preferably from 2 to 4, and in particular 2, epoxy groups. The epoxy groups are in particular glycidyl ether groups of the type produced during the reaction of alcohol groups with epichlorohydrin. The epoxy resins can involve low-molecular-weight compounds which generally have an average molar mass (Mn) smaller than 1000 g/mol, or can involve higher-molecular-weight compounds (polymers). Polymeric epoxy resins of this type preferably have a degree of oligomerization of from 2 to 25, particularly preferably from 2 to 10, units. Compounds involved here can be aliphatic or cycloaliphatic, or can have aromatic groups. In particular, the epoxy resins involve compounds having two aromatic or aliphatic 6-membered rings, or involve oligomers of these. Epoxy resins of importance industrially are those obtainable via reaction of epichlorohydrin with compounds having at least two reactive H atoms, in particular with polyols. Particular importance is attached to epoxy resins obtainable via reaction of epichlorohydrin with compounds having at least two, preferably two, hydroxy groups and comprising two aromatic or aliphatic 6-membered rings. Particular compounds of this type that may be mentioned are bisphenol A and bisphenol F, and also hydrogenated bisphenol A and bisphenol F—the corresponding epoxy resins being the diglycidyl ethers of bisphenol A or bisphenol F, or of hydrogenated bisphenol A or bisphenol F. Epoxy resin used in this invention is usually bisphenol A diglycidyl ether (DGEBA). Other suitable epoxy resins in this invention are tetraglycidylmethylenedianiline (TGMDA) and triglycidylaminophenol, or a mixture thereof. It is also possible to use reaction products of epichlorohydrin with other phenols, e.g. with cresols or with phenol-aldehyde adducts, for example with phenol-formaldehyde resins, in particular novolacs. Other suitable epoxy resins are those not deriving from epichlorohydrin. Examples of those that can be used are epoxy resins which comprise epoxy groups by virtue of reaction with glycidyl (meth)acrylate. The invention preferably uses epoxy resins or mixtures thereof which are liquid at room temperature (25° C.). The epoxy equivalent weight (EEW) is the average mass of the epoxy resin in g per mole of epoxy group.

It is preferable that the curable composition of the invention is composed of at least 50% by weight of epoxy resin.

The curable composition of the invention preferably uses epoxy compounds (epoxy resins inclusive of any other organic compounds that are comprised in the composition and that have one or more epoxy groups (for example certain reactive diluents)) and aminic hardeners in a ratio, based on the epoxy functionality and, respectively, the NH functionality, that is approximately stoichiometric. Particularly suitable ratios of epoxy groups to NH functionality are by way of example from 1:0.8 to 1:1.2.

The curable composition of the invention can also comprise other additions, for example diluents, reinforcing fibers (in particular glass fibers or carbon fibers), pigments, dyes, fillers, release agents, tougheners, flow agents, anti-foamers, flame-retardant agents, or thickeners. It is usual to use a functional amount of additions of this type, an example therefore being, for a pigment, an amount which leads to the desired color of the composition. The compositions of the invention usually comprise from 0 to 50% by weight, preferably from 0 to 20% by weight, for example from 2 to 20% by weight, of the entirety of all of the additives, based on the entire curable composition. For the purposes of this invention, additives are any additions to the curable composition that are neither epoxy compounds nor aminic hardeners.

Formula I gives the molecular structure of 2,6-TMDC

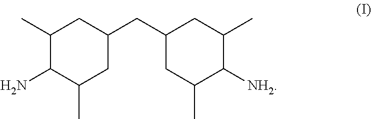 [SMILES: CC1CC(CC2CC(C)C(N)C(C)C2)CC(C)C1N]

The present invention also provides the use of 2,6-TMDC as hardener for epoxy resins in curable compositions with one or more epoxy-group-bearing reactive diluents.

The present invention preferably provides the use of 2,6-TMDC as hardener for epoxy resins in curable compositions with one or more epoxy-group-bearing reactive diluents, where the curable composition comprises an amount of no more than 5% by weight of aromatic diamines, preferably no more than 1% by weight, particularly preferably no more than 0.1% by weight, based on the total amount of all of the aminic hardeners. It is particularly preferable that the present invention provides the use of 2,6-TMDC as hardener for epoxy resins in curable compositions with one or more epoxy-group-bearing reactive diluents without addition of aromatic amines as further hardeners to the curable composition.

2,6-TMDC can be produced by way of example via catalytic ring hydrogenation of xylidine base with hydrogen (WO 2011/082991, example 2-16 and example 2-17) or according to DE 2945614.

The invention further provides a process for producing cured epoxy resins made of the curable composition of the invention. The process of the invention for producing cured epoxy resins of this type brings the components (epoxy resin, epoxy-group-bearing reactive diluent, 2,6-TMDC and optionally other components, for example additives, preferably with the exclusion of aromatic amines) into contact with one another in any desired sequence, and mixes the mixture and then cures same at a temperature of at least 20° C.

It is preferable that the cured epoxy resin is also subjected to thermal post treatment, for example in the context of the curing process or in the context of an optional downstream conditioning process.

The curing process can take place at atmospheric pressure and at temperatures below 250° C., in particular at temperatures below 210° C., preferably at temperatures below 185° C., in particular in a temperature range from 40 to 210° C.

The curing process usually takes place in a mold until dimensional stability has been achieved and the workpiece can be removed from the mold. The process that then takes place in order to dissipate internal stresses in the workpiece and/or in order to complete the crosslinking of the cured epoxy resin is termed heat-conditioning. In principle, it is also possible to carry out the heat-conditioning process prior to removal of the workpiece from the mold, for example in order to complete crosslinking. The heat-conditioning process usually takes place at temperatures on the threshold of dimensional stiffness. The usual heat-conditioning temperatures are from 120 to 220° C., preferably from 150 to 220° C. The cured workpiece is usually exposed to the conditions for heat-conditioning for a period of from 30 to 240 min. Longer heat-conditioning times can also be appropriate, depending on the dimensions of the workpiece.

The invention further provides the cured epoxy resin made of the curable composition of the invention. In particular the invention provides cured epoxy resin which is obtainable/obtained via curing of a curable composition of the invention. In particular, the invention provides cured epoxy resin obtainable/obtained via the process of the invention for producing cured epoxy resins.

Although the hardener 2,6-TMDC involves a cycloaliphatic diamine in which both ortho-positions to each of the amino groups have substitution and although the underlying curable composition comprises epoxy-group-bearing reactive diluents, the cured epoxy resins of the invention have a comparatively high Tg.

The curable compositions of the invention are suitable as coating compositions or as impregnating compositions, as adhesive, for producing moldings and composite materials, or as casting compositions for embedding, binding, or strengthening of moldings. Examples that may be mentioned of coating compositions are lacquers. In particular, the curable compositions of the invention can give scratch-resistant protective lacquers on any desired substrates, e.g. those made of metal, of plastic, or of timber materials. The curable compositions are also suitable as insulation coatings in electronic applications, e.g. as insulation coating for wires and cables. Mention may also be made of the use for producing photoresists. They are also suitable as repair material, e.g. in the renovation of pipes without disassembly of the pipes (cure in place pipe (CIPP) rehabilitation). They are also suitable for the sealing of floors. They are in particular suitable for producing composite materials, especially large components made of composite materials.

Composite materials (composites) comprise different materials, e.g. plastics and reinforcing materials (for example glass fibers or carbon fibers) bonded to one another.

Production processes that may be mentioned for composite materials are the curing of preimpregnated fibers or fiber fabrics (e.g. prepregs) after storage, and also extrusion, pultrusion, winding, and infusion/injection processes, such as vacuum infusion (VARTM), resin transfer molding, (RTM) and also liquid resin press molding processes, such as BMC (bulk mold compression).

The curable composition is particularly suitable for producing large moldings, in particular those with reinforcing fibers (for example glass fibers or carbon fibers), where comparatively long pot lives are required for these, in order to provide reliable filling of the mold and/or reliable impregnation of the fibers.

The invention further provides moldings made of the cured epoxy resin of the invention, composite materials comprising the cured epoxy resin of the invention, and also fibers impregnated with the curable composition of the invention. The composite materials of the invention preferably comprise glass fibers and/or carbon fibers, alongside the cured epoxy resin of the invention.

The glass transition temperature (Tg) can be determined by means of dynamic mechanical analysis (DMA), for example in accordance with the standard DIN EN ISO 6721, or by using a differential calorimeter (DSC), for example in accordance with the standard DIN 53765. In the case of DMA, a rectangular test specimen is subjected to torsional load at an imposed frequency and with prescribed deformation. The temperature here is raised at a defined gradient, and storage modulus and loss modulus are recorded at fixed intervals. The former represents the stiffness of a viscoelastic material. The latter is proportional to the energy dissipated within the material. The phase displacement between the dynamic stress and the dynamic deformation is characterized by the phase angle 6. The glass transition temperature can be determined by various methods: as maximum of the tan 6 curve, as maximum of the loss modulus, or by means of a tangential method applied to the storage modulus. When the glass transition temperature is determined with use of a differential calorimeter, a very small amount of specimen (about 10 mg) is heated in an aluminum crucible and the heat flux is measured in relation to a reference crucible. This cycle is repeated three times. The glass transition is determined as average from the second and third measurement. The Tg transition can be evaluated from the heat flux curve by way of the inflection point, by a half-width method, or by the midpoint-temperature method.

The expression pot life or else gel time means a property that is usually utilized in order to compare the reactivity of various resin/hardener combinations and/or resin/hardener-mixture combinations. The measurement of pot life is a method for characterizing the reactivity of lamination systems by means of a temperature measurement. As a function of application, there are established deviations from the parameters (quantity, test conditions, and test method) described in those contexts. The pot life is determined here as follows: 100 g of the curable composition comprising epoxy resin and hardener or hardener mixture are charged to a container (usually a paperboard beaker). A thermometer is immersed in this curable composition, and measures and stores the temperature value at defined time intervals. As soon as said curable composition has solidified, the measurement process is terminated, and the time required to reach the maximum temperature is determined. In the event that the reactivity of a curable composition is too small, said measurement is carried out at increased temperature. It is always necessary to state the test temperature alongside the pot life.

The following, non-limiting examples will now be used for further explanation of the invention.

### EXAMPLE 1

### Production of Curable Compositions (Epoxy Resin Composition) Without Reactive Diluents and Testing of Reactivity Profile

The formulations to be compared with one another were produced via mixing stoichiometric amounts of the respective cycloaliphatic amine (IPDA (Baxxodur EC 210, BASF), DMDC (Baxxodur EC 331, BASF) or 2,6-TMDC) with an epoxy resin (Epilox A19-03, Leuna Harze, EEW 182) based on bisphenol A diglycidyl ether, and subjected immediately to testing. The 2,6-TMDC was produced in accordance with the specification in WO 2011/082991, example 2-16.

The rheological measurements for the testing of the reactivity profile of the cycloaliphatic amines with epoxy resins were made on a shear-stress-controlled plate-on-plate rheometer (MCR 301, Anton Paar) with plate diameter 25 mm and a gap of 1 mm, at various temperatures.

Test 1a): Comparison of the time required for the freshly produced epoxy resin composition to reach a viscosity of 10 000 mPa*s at a defined temperature. The measurement was carried out in rotation in the abovementioned rheometer at various temperatures (23° C., 40° C., 60° C., and 80° C.)

TABLE 1
Isothermal viscosity increase to 10 000 mPa*s

| Temperature | IPDA | | DMDC | | 2,6-TMDC | |
|---|---|---|---|---|---|---|
| 23° C. | 78 | min | 136 | min | 199 | min |
| 40° C. | 65 | min | 120 | min | 288 | min |
| 60° C. | 40 | min | 56 | min | 126 | min |
| 80° C. | 11 | min | 20 | min | 53 | min |
| Initial viscosity | 2442 | mPa*s | 3910 | mPa*s | 5623 | mPa*s |
| at 23° C. | | | | | | |

The time for the isothermal viscosity rise is markedly higher for 2,6-TMDC than for the other diamines tested.

Test 1b): Comparison of gel times. The measurement was carried out in oscillation in the abovementioned rheometer at 60° C., 75° C., 90° C., and 110° C. The point of intersection of loss modulus (G″) and storage modulus (G′) gives the gel time.

TABLE 2
Isothermal gel times

| Temperature | IPDA | DMDC | 2,6-TMDC |
|---|---|---|---|
| 60° C. | 73 min | 117 min | 436 min |
| 75° C. | 38 min | 65 min | 254 min |
| 90° C. | 24 min | 34 min | 172 min |
| 110° C. | 14 min | 12 min | 117 min |

The isothermal gel time is markedly higher for 2,6-TMDC than for the other diamines tested. It is also markedly higher than the isothermal gel time of 73 min at 60° C. for 2,5-TMDC disclosed in U.S. Pat. No. 4,946,925. In particular at high temperatures it can be seen that only 2,6-TMDC can achieve a marked increase in gel time: relatively high temperatures can be required in particular in order to achieve more advantageous initial viscosities in the production of moldings.

Test 1c): Comparison of pot lives. In each case, 100 g of the epoxy resin composition were mixed in a paper beaker and provided with a thermometer, and stored at 23° C. and 40° C. The temperature of the specimen was recorded as a function of time. The pot life is the time required by the specimen to reach maximum temperature.

TABLE 3
Pot lives at various storage temperatures (the data between
parentheses being the maximum temperature reached)

| Storage temperature | IPDA | DMDC | 2,6-TMDC |
|---|---|---|---|
| 23° C. | 186 min | 485 min | 1784 min |
| | (187° C.) | (34° C.) | (26° C.) |
| 40° C. | 62 min | 112 min | 351 min |
| | (241° C.) | (207° C.) | (52° C.) |

The pot life is considerably longer for 2,6-TMDC than for the other diamines tested, and the maximum temperature is markedly lower. In the case of the storage temperature of 23° C., only a slight temperature rise of 3° C. was observed for the specimen using 2,6-TMDC, and no completion of hardening was observed even after more than 30 hours. In the case of the storage temperature of 40° C., a temperature rise of 12° C. was observed. At a storage temperature of 40° C., comparison with DMDC, which is structurally similar, revealed a 213% increase in pot life and a 155° C. reduction in maximum temperature. 2,6-TMDC is therefore in particular suitable for epoxy resin systems where a long time available for processing is required together with minimized temperature rise during hardening.

### EXAMPLE 2

### Exothermic Profile of the Curable Composition (Epoxy Resin Composition) and Glass Transition Temperatures of the Cured Epoxy Resins (Hardened Thermosets)

The DSC testing of the curing reaction of cycloaliphatic amines (IPDA (Baxxodur EC 210, BASF), DMDC (Baxxodur EC 331, BASF), or 2,6-TMDC) with an epoxy resin (Epilox A19-03, Leuna Harze, EEW 182) based on bisphenol A diglycidyl ether to determine onset temperature (To), maximum temperature (Tmax) and exothermic energy (ΔE), and also the determination of the glass transition temperatures (Tg) with various curing protocols, were carried out in accordance with ASTM D3418. 2 procedures were carried out in each case. The data for 2,5-TMDC from U.S. Pat. No. 4,946,925 are shown for comparison in the table. In other variants of the curable compositions based on DMDC and, respectively, 2,6-TMDC as hardener, resin components were used which included a proportion of in each case 10 or 20% by weight (based on the entire resin component) of the reactive diluents hexanediol bisglycidyl ether (HDDE, Epilox P13-20, Leuna-Harze), butanediol bisglycidyl ether (BDDE, Epilox P13-21, Leuna), C₁₂-C₁₄-alkyl monoglycidyl ether (Epilox P13-18, Leuna-Harze), or propylene carbonate (PC, Huntsman), and the Tg was likewise determined.

TABLE 4
Exothermic profile and glass transition temperatures (where the various
curing protocols underlying the Tg measurements are given in the first
column in brackets for the respective Tg measurement); the abbreviation
“Exo” means that in this instance an exothermic reaction was
observed and no Tg determination was therefore possible.

| | | | | | 2,5-TMDC |
|---|---|---|---|---|---|
| | | | | | (in accordance |
| | Proce- | | | 2,6- | with U.S. Pat. |
| | dure | IPDA | DMDC | TMDC | No. 4,946,925) |
| To | | 88° C. | 97° C. | 110° C. | 96° C. |
| Tmax | | 117° C. | 131° C. | 148° C. | 128° C. |
| ΔE | | 441 J/g | 360 J/g | 273 J/g | 325° C. |
| Tg (1 h 80° C.) | 1st | Exo | Exo | Exo | Exo |
| | 2nd | 159° C. | 171° C. | 153° C. | 182° C. |
| Tg (2 h 80° C.) | 1st | Exo | Exo | Exo | Exo |
| | 2nd | 159° C. | 171° C. | 154° C. | 186° C. |
| Tg (2 h 80° C., | 1st | 154° C. | 153° C. | 116° C. | 163° C. |
| 1 h 150° C.) | 2nd | 157° C. | 172° C. | 156° C. | 184° C. |
| Tg (2 h 80° C., | 1st | 156° C. | 158° C. | 134° C. | 170° C. |
| 2 h 150° C.) | 2nd | 158° C. | 172° C. | 160° C. | 180° C. |
| Tg (2 h 80° C., | 1st | 158° C. | 160° C. | 140° C. | 167° C. |
| 3 h 150° C.) | 2nd | 158° C. | 172° C. | 161° C. | 185° C. |
| Tg (4 h 80° C., | 1st | 159° C. | 169° C. | 148° C. | 176° C. |
| 1 h 200° C.) | 2nd | 159° C. | 174° C. | 162° C. | 186° C. |
| Tg (2 h 80° C., | 1st | 159° C. | 178° C. | 166° C. | 187° C. |
| 3 h 150° C., | 2nd | 159° C. | 177° C. | 172° C. | 188° C. |
| 2 h 200° C.) | | | | | |
| Tg (1 K/min to | 1st | | Exo | Exo | |
| 180° C.) | 2nd | | 196° C. | 197° C. | |
| Tg (1 K/min to | 1st | | 166° C. | Exo | |
| 180° C.) + | 2nd | | 166° C. | 174° C. | |
| 10% of HDDE | | | | | |
| Tg (1 K/min to | 1st | | 168° C. | Exo | |
| 180° C.) + | 2nd | | 168° C. | 177° C. | |
| 10% of BDDE | | | | | |
| Tg (1 K/min to | 1st | | 150° C. | 159° C. | |
| 180° C.) + | 2nd | | 151° C. | 160° C. | |
| 20% of BDDE | | | | | |
| Tg (1 K/min to | 1st | | 143° C. | 153° C. | |
| 180° C.) + | 2nd | | 144° C. | 154° C. | |
| 10% of P13-18 | | | | | |
| Tg (1 K/min to | 1st | | 115° C. | 123° C. | |
| 180° C.) + | 2nd | | 115° C. | 124° C. | |
| 20% of P13-18 | | | | | |
| Tg (1 K/min to | 1st | | 135° C. | 138° C. | |
| 180° C.) + | 2nd | | 135° C. | 139° C. | |
| 10% of PC | | | | | |
| Tg (1 K/min to | 1st | | 120° C. | 121° C. | |
| 180° C.) + | 2nd | | 133° C. | 128° C. | |
| 20% of PC | | | | | |

2,6-TMDC can achieve excellent thermal properties (for example comparatively high Tg) together with reduced reactivity and long times available for processing. In the case of slow hardening (1 K/min to 180° C.) a markedly higher glass transition temperature can be achieved for 2,6-TMDC, and corresponds to that achievable with DMDC. Addition of the epoxy-group-bearing reactive diluents HDDE, BDDE, or P13-18 of the invention led (as is usual with reactive diluents) to a reduced glass transition temperature not only for the DMDC-cured epoxy resins but also with the 2,6-TMDC-cured epoxy resins, but this reduction was unexpectedly found to be markedly smaller in the case of the curable composition of the invention with 2,6-TMDC.

In contrast, the addition of a reactive diluent which is not based on epoxy groups such as PC led to a similarly significant decrease of Tg for 2,6-TMDC as well as for DMDC. In order to achieve a highest possible Tg, the combination of 2,6-TMDC and an epoxy-group-bearing reactive diluent is crucial.

### EXAMPLE 3

### Mechanical Tests on Cured Epoxy Resins (Hardened Thermosets) Without Reactive Diluents

For testing of the mechanical properties of the thermosets made from cycloaliphatic amines (IPDA (Baxxodur EC 210, BASF), DMDC (Baxxodur EC 331, BASF), or 2,6-TMDC) with an epoxy resin (Epilox A19-03, Leuna Harze, EEW 182) based on bisphenol A diglycidyl ether, the two components were mixed in a Speedmixer (1 min at 2000 rpm) and degassed by applying vacuum (1 mbar) at 23° C., and moldings were then manufactured by using various curing processes (A: 2 h 80° C., 3 h 125° C. (for IPDA, DMDC, and 2,6-TMDC curing) and B: 2 h 80° C., 3 h 150° C. (only for 2,6-TMDC curing)). The mechanical tests were carried out in accordance with ISO 527-2:1993 and ISO 178:2006. The corresponding values for 2,5-TMDC from U.S. Pat. No. 4,946,925 were compared with the values for curing procedure B using 2,6-TMDC.

TABLE 5
Mechanical properties of the thermosets (where the values
for 2,5-TMDC are taken from U.S. Pat. No. 4,946,925)

| | Curing procedure A: | | | Curing procedure B: | |
|---|---|---|---|---|---|
| | 2 h 80° C., 3 h 125° C. | | | 2 h 80° C., 3 h 150° C. | |
| | | | 2,6- | 2,6- | 2,5- |
| | IPDA | DMDC | TMDC | TMDC | TMDC |
| Tensile | 82 | 72 | 89 | 83 | 66 |
| strength | | | | | |
| (in MPa) | | | | | |
| Tensile | 4.6 | 3.7 | 7.9 | 6.9 | 3.9 |
| elongation | | | | | |
| (in %) | | | | | |
| Tensile | 2947 | 2727 | 3055 | 2997 | 3509 |
| modulus E | | | | | |
| (in MPa) | | | | | |
| Flexural | 132 | 117 | 124 | 128 | 163 |
| strength | | | | | |
| (in MPa) | | | | | |
| Flexural | 6.1 | 5.9 | 6.1 | 5.96 | 3.9 |
| elongation | | | | | |
| (in %) | | | | | |
| Flexural | 3087 | 2805 | 3117 | 3058 | 3337 |
| modulus | | | | | |
| (in MPa) | | | | | |

In the case of curing procedure A, a marked increase in the tensile elongation for 2,6-TMDC is apparent in comparison with the other hardeners tested. The other mechanical data reveal either a slightly increased value or a comparable value. It was thus possible to show that an improved tensile elongation value can be achieved with 2,6-TMDC without any sacrifice in other mechanical properties. In the case of curing procedure B, 2,6-TMDC exhibits a marked increase in tensile elongation in comparison with 2,5-TMDC.

1. A curable composition, comprising:
an epoxy resin;
an epoxy-group-bearing reactive diluent; and
2,2′,6,6′-tetramethyl-4,4′-methylenebis(cyclohexylamine),
wherein said curable composition is free from aromatic diamines.

2. The curable composition according to claim 1, wherein the epoxy-group-bearing reactive diluent is selected from the group consisting of 1,4-butanediol bisglycidyl ether, 1,6-hexanediol bisglycidyl ether, glycidyl neodecanoate, glycidyl versatate, 2-ethylhexyl glycidyl ether, neopentyl glycol diglycidyl ether, p-tert-butyl glycidic ether, butyl glycidic ether, nonylphenyl glycidic ether, p-tert-butylphenyl glycidic ether, phenyl glycidic ether, o-cresyl glycidic ether, polyoxypropylene glycol diglycidic ether, trimethylolpropane triglycidic ether, glycerol triglycidic ether, triglycidylpara-aminophenol, divinylbenzyl dioxide, and dicyclopentadiene diepoxide.

3. The curable composition according to claim 1, wherein the epoxy resin is selected from the group consisting of diglycidyl ether of bisphenol A, diglycidyl ether of bisphenol F, diglycidyl ether of hydrogenated bisphenol A, and diglycidyl ether of hydrogenated bisphenol F.

4. A process for hardening an epoxy resin, the process comprising adding 2,2′,6,6′-tetramethyl-4,440 - methylenebis(cyclohexylamine) in a curable composition with one or more epoxy-group-bearing reactive diluents.

5. The process according to claim 4, wherein an amount of no more than 5% by weight, based on a total amount of all of the aminic hardeners, of aromatic diamines is added to the curable composition.

6. A process for producing cured epoxy resins, the process comprising exposing the curable composition of claim 1 to a temperature of at least 20° C.

7. A cured epoxy resin obtained by the process according to claim 6.

8. A cured epoxy resin obtained by curing the curable composition according to claim 1.

9. A molding, comprising the cured epoxy resin according to claim 7.

10. A composite material, comprising the cured epoxy resin according to claim 7.

11. The composite material according to claim 10, further comprising glass fibers and/or carbon fibers.

12. A fiber which has been impregnated with the curable composition according to claim 1.

13. The curable composition according to claim 2, wherein the epoxy resin is selected from the group consisting of diglycidyl ether of bisphenol A, diglycidyl ether of bisphenol F, diglycidyl ether of hydrogenated bisphenol A, and diglycidyl ether of hydrogenated bisphenol F.

14. A process for producing cured epoxy resins, the process comprising exposing the curable composition of claim 2 to a temperature of at least 20° C.

15. A process for producing cured epoxy resins, the process comprising exposing the curable composition of claim 3 to a temperature of at least 20° C.
